(19) United States
(12) Patent Application Publication
(10) Pub. No.: US 2004/0202298 A1
(43) Pub. Date: Oct. 14, 2004

(54) Collect calling party identification

(76) Inventors: Ismael Lopez, Berwyn, IL (US); Lei Qian, Naperville, IL (US)

Correspondence Address: HARNESS, DICKEY & PIERCE, P.L.C., P.O. BOX 8910, RESTON, VA, 20195, US

(21) Appl. No.: 09/740,466

(22) Filed: Dec. 19, 2000

(51) Int. Cl. H04M 11/00; H04M 3/00; H04M 5/00

(52) U.S. Cl. 379/142.01; 379/245; 379/247; 379/93.17; 379/93.23

(57) ABSTRACT

The collect call party identification service disclosed enables a service provider to identify a person who makes an assistance-free collect call and to transmit the caller's identity on the called phone regardless of the phone number from which the call is made and before any charges are incurred. The service provider, in a database controlled by the service provider, lists and identifies each person in a defined group with a personal identification number such as his/her phone number, social security number or the like. The Collect Calling Party Identification service is invoked by using a prefix such as *99. A person listed in the service provider's database and having been assigned a personal identification number can make a collect call without the assistance of an operator by dialing *99 plus his/her personal identification number. Upon confirmation from the database that the caller is listed in the database, the caller making the collect call then inputs the number that he/she is attempting to reach. When the call is received by the called party, the identification of the person making the collect call is displayed on the receiving telephone for viewing by the called person before any charges are incurred. Thus, the called party can identify the calling party regardless of the location of the calling phone prior to deciding whether or not to answer the phone.

### BACKGROUND OF THE INVENTION

1. Field of the Invention

This invention relates generally to collect calls, and in particular to the provision of identifying the calling party making a collect call without the assistance of an operator.

2. Background of the Invention

Collect calls are an important feature in wire-line and wireless telecommunications. A collect call can be delivered to the called party either with or without the assistance of an operator. To save money, a caller may choose not to use the assistance of the operator. But, by doing so, the called party is not sure of the calling party's identity and may choose not to answer the phone. With caller ID service, the called person may be made aware of the phone number of the telephone being used to make the collect call but not the identity of the caller.

Caller ID is a service by a telephone service provider that provides a user with information regarding an incoming call. Typically, a display associated with a user's telephone, either integrated into the telephone or as part of an adjunct box coupled to the telephone, displays the telephone number and/or name associated with an incoming call. In Type I Caller ID, which occurs when the user's telephone is in an on-hook state (i.e., the user is not already engaged in a telephone call while the incoming call is arriving), the Caller ID data is provided by a central office of the service provider as frequency shift keying (FSK) data between the first and second rings. The user, after the first ring, can thus look at the display to decide, based on the displayed information, whether to answer an incoming telephone call.

In Type II Caller ID, also known as Caller ID with Call Waiting (CID/CW), the user's telephone is in an off-hook state, ie., already engaged in a telephone call while the incoming call is arriving). In addition to the familiar audible tone, known as a Subscriber Alert Signal (SAS tone), that alerts a user to an incoming call waiting telephone call, the central office provides a Caller ID Alert Signal (CAS tone) to inform the user's telephone equipment that Caller ID data is about to be transmitted, pending receipt of an acknowledgment from the user's telephone equipment. Based of the CAS tone, the user's telephone briefly mutes its transducers (i.e., microphone and speaker) so that the FSK data in not heard by the user or corrupted by the user's speech. The muting period is sufficiently brief that it does not appreciably disrupt the voice communication between the parties to the conversation. The user, after hearing the SAS tone, can then view the display to determine whether to flash-hook over to the incoming call and temporarily place the existing call into a hold status. The flash-hook operation is accomplished by briefly pressing or activating a switch-hook button, which is normally in a first position, such as down, when the telephone is on-hook, and in a second position, such as up, when the telephone is off-hook, to alert the central office to the desire to switch to the incoming call.

When a telephone is equipped to receive Type II Caller ID data, a user who elects to flash-hook to an incoming call, based, for example, on viewing the Caller ID data associated with the incoming call, may subsequently decide to switch back to the original call and temporarily place the newer call in a hold status, and can do so by again activating the switch-hook. The user can decide to hold status, and can do so by again activating the switch-hook. The user can switch back and forth between the two calls as often as desired. However, activation of the switch-hook does not automatically result in a flash-hook operation. Frequently, the flash-hook operation does not occur, and the user thus must verbally confirm the identity of the distant party when switching between calls.

Even in those instances where caller ID technology enables the called party to see the telephone number of the calling party making the collect call, the identity of the calling party can still be a mystery. For example, lack of knowledge about the identity of the calling party occurs when the collect call originates from a hotel, a hospital, an airport, an office, a public pay phone. etc.

As frequently happens, when a collect call which is not operator-assisted is received, the called person may choose not to answer the phone, especially if the number displayed on the handset is unfamiliar to the called person. However, the person receiving the collect call may not want to miss the call if it is from a close family member or friend. There is a need, therefore, for a process for automatically identifying a caller making an assistance-free collect call.

### SUMMARY OF THE INVENTION

The collect call party identification service disclosed enables a service provider to identify a person who makes an assistance-free collect call and to transmit the caller's identity on the called phone regardless of the phone number from which the call is made and before any charges are incurred. The service provider, in a database controlled by the service provider, lists and identifies each person in a defined group with a personal identification number such as his/her phone number, social security number or the like. The Collect Calling Party Identification service is invoked by using a prefix such as *99. A person listed in the service provider's database and having been assigned a personal identification number can make a collect call without the assistance of an operator by dialing *99 plus his/her personal identification number. Upon confirmation from the database that the caller is listed in the database, the caller making the collect call then inputs the number that he/she is attempting to reach. When the call is received by the called party, the identification of the person making the collect call is displayed on the receiving telephone for viewing by the called person before any charges are incurred. Thus, the called party can identify the calling party regardless of the location of the calling phone prior to deciding whether or not to answer the phone.

### BRIEF DESCRIPTION OF THE DRAWINGS

For a more complete understanding of the present invention, and the advantages thereof, reference is now made to the following description taken in conjunction with the accompanying drawings, in which:

FIG. 1 illustrates the process for use by a telecommunication service provider to enable a called person to clearly determine the identify of a person making a collect call placed without the assistance of an operator.

### DETAILED DESCRIPTION

This invention relates to a new service which is provided by a telephone service provider that allows a person receiving a collect call to identify the caller of a collect call even when it is placed without the assistance of an operator. Initially, the identifier of a specific group of individuals which are not limited in number are given to the service provider. The service provider assigns a unique personal identification number to each individual of the specific group. For example, the personal identification number of each individual can be one of a series of continuous digits, i.e., 10,000-99,000, or the individual home wireless or office telephone number, or the individual's social security number of the like. The name of each individual of the specific group together with his/her personal identification number are stored in a database that can be located in a central office of the telephone service provider.

The personal identification number of each individual of the specific group is under the control of the service provider, and all of the personal identification numbers are stored in database 20. In addition, the collect calling party identification service here disclosed is assigned a feature service code such as *99. The number *99, which is designated by the service provider, is the prefix for the collect calling party identification service which identifies and activates the service here disclosed. To use the service here disclosed, the number *99 is dialed first. Thus, the full identification input number when using this service is *99 plus the personal identification number of the calling party making the collect call plus the telephone number of the person being called which can be divided in the sequences as follows.

To originate a call having the Collect Calling Party Identification service here disclosed, the caller dials *99+Telphone Number of the called person where it is here assumed that *99 is the service code number. Immediately thereafter the caller is asked to provide the full identification number, i.e., the caller's Personal identification Number through a playback announcement that can be provided by the control switch in the central office. Thus, if it is assumed that the subscriber's PIN is 11349, then the caller will input the numbers 11347 to identify himself/herself. The collected digits, the Telephone Number+11347 are sent to the telecommunication service provider's database for processing.

The implementation of this invention is done in the service provider database which can be associated with the central office. This database is shared by all phone subscribers that are served by this switch and by the service provider. It stores subscription information of the phone users, such as the phone serial number, call restrictions that are applied to this phone, and whether it has call waiting, call forwarding, caller ID and the like. By entering the subscriber's phone number, e.g., 7082678215, the phone service provider can query or modify the subscription information under this phone number.

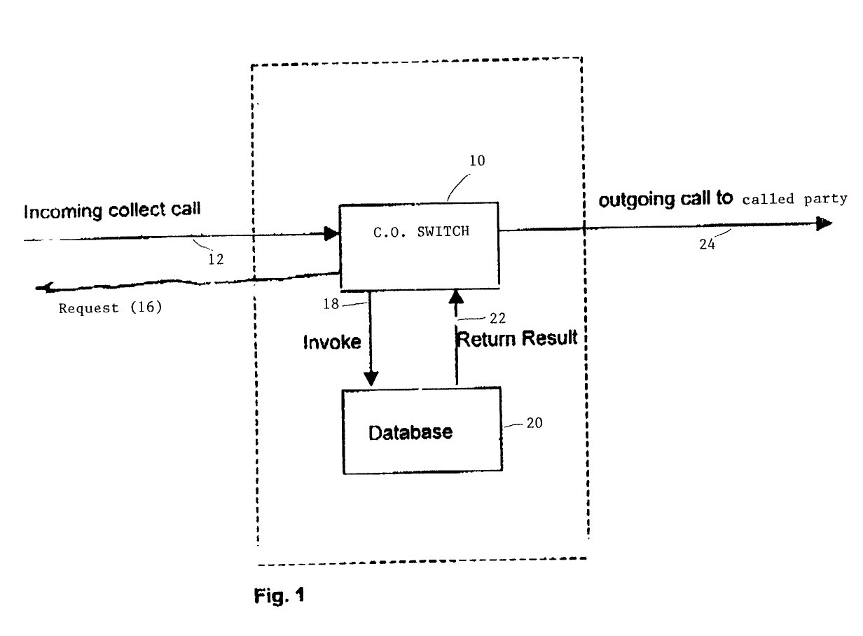

FIG. 1 illustrates the basic call flow process when a subscriber activates the Collect Calling Party Identification service here disclosed. FIG. 1 discloses two components, the switch 10 in the central office and the database for the Collect Calling Party Identification Service. The database 20, which stores the various personal identification numbers and the identification or name of each party, can be either integrated with the switch in the central office or be a stand-alone database.

If it is assumed that the number *99 is the activation code for this service, that 11347 is the personal identification number of the person making a collect call without the assistance of an operator, and 708-267-8215 is the phone number of the person being called, then the process proceeds as follows:

A. The subscriber dials *99 to activate the Collect Calling Party Identification service (12).

B. Immediately thereafter dials 708-267-8215, the number being called.

C. The central office switch 10 receives the activation request and sends a message 16 to the caller requesting the caller's personal identification number.

D. From the personal identification number, the central office switch invokes (18) the service provider's database 20 to identify the person making the collect call.

E. Thereafter the return result message 22, which is the identity of the caller, is generated and sent to the central office switch 10.

F. The central office switch receives the return result message and sends (24) the identity (the name) of the person making the collect call to the person being called.

G. The name of the calling party is received by and displayed on the phone of the called party.

Clearly, by seeing the name of the caller, the called party knows the identity of the caller regardless of which phone was used to make the collect call. At this time, the called party, having identified the person making the collect call, can decide whether or not to answer the phone before a chargeable connection is made.

Various modifications of the invention will become apparent to those skilled in the art. All such variations which basically rely on the teachings through which the invention has advanced the art are properly considered within the scope of the invention.

1. A method of identifying a calling party placing a collect call without the assistance of an operator comprising the steps of assigning a personal identification number to people of a group;
using the personal identification number to identify a person making a collect call without the assistance of an operator; and
sending the identity of the person placing the collect call to the phone of the party being called before a chargeable connection is made.

2. The method of claim 1 further comprising the step of establishing a database of the group of people and the personal identification number assigned to each person of the group.

3. The method of claim 2 wherein the person's personal identification number is the phone number assigned to the person.

4. The method of claim 3 wherein the phone number is the person's home phone number.

5. The method of claim 2 wherein the phone number is the person's wireless phone number.

6. The method of claim 2 wherein the person's personal identification number is the person's social security number.

7. The method of claim 2 wherein the number of people of the group is determined by the size of the database.

8. The method of claim 7 wherein the database is controlled by a telecommunication service provider.

9. The method of claim 7 wherein the identity of the person making the call and being sent to the phone of the party being called is the person's name.

10. The method of claim 1 further comprising the step of matching the digits of the person's personal identification number to stored digits to obtain the identity of the person making the collect call.

11. The method of claim 10 wherein readable digits are numeric.
